(19) United States
(12) Patent Application Publication
(10) Pub. No.: US 2010/0204857 A1
(43) Pub. Date: Aug. 12, 2010

(54) DIAGNOSTIC SYSTEM AND METHOD FOR MONITORING A RAIL SYSTEM

(75) Inventors: Paul Forrest, Ashbourne (GB); Michael Provost, Nottingham (GB); Jeremy Lovell, Derby (GB)

Correspondence Address: HOWREY LLP-EU, C/O IP DOCKETING DEPARTMENT, 2941 FAIRVIEW PARK DR., SUITE 200, FALLS CHURCH, VA, 22042, US

(73) Assignee: BOMBARDIER TRANSPORTATION GMBH, BERLIN (DE)

(21) Appl. No.: 12/441,724

(22) PCT Filed: Sep. 18, 2007
(86) PCT No.: PCT/EP07/08116

§ 371 Date: Mar. 9, 2010

(30) Foreign Application Priority Data
Sep. 18, 2006 (EP) 06019461.0

(51) Int. Cl. B61L 27/00; G06F 19/00

(52) U.S. Cl. 701/19; 701/33; 701/32

(57) ABSTRACT

The vehicles (12) of at least one fleet of rail vehicles are provided with on-board sensors (22) and rail vehicle positioning means (23). The rail infrastructure on which the rail vehicles circulate is provided with fixed rail infrastructure sensors (18). The rail infrastructure-related sensor data is merged with the rail vehicle-related sensor data, with location data representative of the location of the rail infrastructure-related sensors and with the rail vehicle position data for generating series of categorized event data representative of the occurrence of categorized events at a given location on the rail infrastructure over time and/or on a given rail vehicle of the fleet over time. The series of categorized events data representative of at least one category of events can be compared over any predetermined period of time to identify any location of the rail infrastructure and/or any rail vehicle which exhibits a series of events data that is significantly different from the other locations of the rail infrastructure and/or rail vehicles of the fleet over said predetermined period of time.

### TECHNICAL FIELD OF THE INVENTION

The invention relates to a diagnostic system and a method for monitoring a rail system comprising a rail infrastructure and at least one fleet of rail vehicles circulating on the rail infrastructure, and for identifying particular faults relating to components of the rail system.

### BACKGROUND ART

Today, rail system operators are under increasing pressure to keep their trains running on time and for longer. Passenger expectations for comfort are greater than ever whilst increasingly sophisticated equipment creates both new challenges and opportunities for the rail system operator and its maintenance teams. The efficiency of any rail company hinges on the safety, reliability and availability of its trains. Yet with maintenance regimes typically being mileage or timescale related, as opposed to condition driven, trains can be out of operation for unnecessary servicing, or unforeseen repairs. Similar issues are also apparent when considering the operation and maintenance of the rail infrastructure (rails, signals, bridges, earthworks, etc)

A system and method for monitoring the condition of and diagnosing failures in a rail vehicle or a fleet of rail vehicles using an integrated on-board system able to communicate with remote off-board system diagnosing failures in a rail vehicle is known from WO 2004/024531. This system focuses on the data generated by on-board sensors and suggests processing sensor data on-board to generate condition data relating to one or more components of the rail vehicle before transferring the fully processed condition data to an off-board system.

WO 01/015001 describes a system and method for integrating the diverse elements involved in the management of a fleet of locomotives, making use of a global information network for collecting, storing, sharing and presenting information. In order to identify faults, values for given parameters measured on a vehicle are compared over a period of time and these values are compared with historical data for identical rail vehicles. This enables correlation of trend data with a dedicated fault occurrence experience database. Once a fault has been identified, the estimated time of failure is also predicted and the optimum time the rail vehicle should be maintained is determined by resorting to the relevant trend data for the identified unit and comparing that data with a projected time-of-failure knowledge base which has been inputted into the database for the calculation. Based on the severity of the failure, a repair location is also selected and a repair order is issued. This system, however, does not take advantage of data acquired from the rail infrastructure itself for identifying faults on the rail vehicles. Moreover, the system is not able to identify faults relating to the infrastructure of the rail system.

In WO 2005/015326, it was proposed to monitor the condition of rail infrastructure as well as the condition of rail vehicles by means of a data processor which includes a plurality of separate feature detectors, each for monitoring a specific aspect of data obtained from the rail vehicles. Primary data is supplied by on-board vibration or acoustic sensors, while secondary data relative to the location, the identity of the vehicles or the ambient conditions and operation of the vehicles is supplied by on-board devices and fused with the primary data. The feature detectors include a model of normality, which may be learned from training data sets, and compare the input signals to the model of normality to detect departures from normality. However, this system does not take advantage of data from both mobile and stationary sources.

U.S. Pat. No. 6,125,311 discloses a railway operation monitoring and diagnosing system including a predictor which generates anticipated values of selected railway operation state (ROS) variables and compares the measured values of the selected ROS variables with their anticipated values to detect and diagnose discrepancies. The predictor uses a train performance simulator and a master train schedule as well as past measured values of ROS to issue predictions.

This document, however, fails to disclose the earlier steps of development of the diagnostic system, i.e. before an accurate predictor becomes available.

There is therefore a need for a system that more fully integrates the data from rail infrastructure and from the rail vehicles to allow more efficient monitoring of the complete rail system (infrastructure and vehicles), and in particular to enable identification of previously unknown failure signatures.

### SUMMARY OF THE INVENTION

The present invention addresses this problems by providing a diagnostic system for monitoring a rail system comprising a rail infrastructure and at least one fleet of rail vehicles circulating on the rail infrastructure, the diagnostic system comprising:
on-board data acquisition means comprising sensors and pre-processing means responsive to the sensors for generating rail vehicle-related data representative of the operation of monitored rail vehicle components and/or of the rail vehicle environment of each rail vehicle of the fleet,
rail vehicle positioning means for generating position data representative of the position of each rail vehicle of the fleet;
rail infrastructure data acquisition means comprising sensors fixed relative to the rail infrastructure and pre-processing means responsive to the sensors for generating rail infrastructure-related data representative of rail infrastructure components and/or of the rail infrastructure environment;
a database of the rail infrastructure comprising location data representative of the location of each of the sensors fixed relative to the rail infrastructure;
data processing means for merging the rail infrastructure-related data, the rail vehicle-related data from at least a subset of several rail vehicles of the fleet, the location data and the position data and for responsively generating series of categorized event data representative of the occurrence of categorized events at a given location on the rail infrastructure over time and/or on a given rail vehicle of the fleet over time; and
a data comparing means for comparing the series of categorized event data representative of at least one category of events over any predetermined period of time and for identifying any location of the rail infrastructure and/or any rail vehicle which exhibits a series of events data that is significantly different from the other locations of the rail infrastructure and/or rail vehicles of the fleet over said predetermined period of time.

Thanks to the merging of rail infrastructure-related data with rail vehicle-related data, it becomes possible to more thoroughly analyse events and to merge data that are correlated, or are likely to have a causal relationship, so as to deliver more relevant failure prediction analyses.

The data comparing means is used to compare several time series of events data for several vehicles or several rail infrastructure components of the same type to identify previously unknown failure signatures, in order to issue a diagnosis even if no accurate prediction tool is available.

The data comparing means may further comprise a data categorization means including an operator interface for defining categories of events by entering which rail vehicle-related data and which rail infrastructure-related data is included in any category of events.

Thus, the definition of categories can be modified at will, allowing the operator to refine his analyses when his understanding of specific failures and failure symptoms increases.

The data comparing means may further comprise time period selecting means for selecting said predetermined period of time, and/or means for selecting said subset of rail vehicles and/or rail infrastructure components.

The comparison means may comprise counting means for counting the number of occurrences of a predetermined event in each series, and means for comparing said numbers of occurrences, either graphically or numerically. Such graphical displays may include, but are not limited to, histograms, bar charts, column charts, line charts, scatter plots and/or time series plots.

According to a further aspect of the invention, there is provided a method for monitoring a rail system comprising a rail infrastructure and at least one fleet of rail vehicles circulating on the rail infrastructure, the method comprising:
generating rail vehicle-related data representative of the operation of monitored rail vehicle components and/or of the environment of each rail vehicle of the fleet,
generating position data representative of the position of each rail vehicle of the fleet;
generating rail infrastructure-related data representative of rail infrastructure components and/or of the rail infrastructure environment;
a database of the rail infrastructure comprising;
merging the rail infrastructure-related data, the rail vehicle-related data from at least a subset of several rail vehicles of the fleet, with location data from a location database representative of the location of each of the sensors fixed relative to the rail infrastructure and the position data of each rail vehicle of the subset for responsively and generating series of categorized events data representative of the occurrence of categorized events at a given location on the rail infrastructure over time and/or on a given rail vehicle of the fleet over time; and
comparing the series of categorized event data representative of at least one category of events over any predetermined period of time and for identifying any location of the rail infrastructure and/or any rail vehicle which exhibits a series of events data that is significantly different from the other locations of the rail infrastructure and/or rail vehicles of the fleet over said predetermined period of time.

### BRIEF DESCRIPTION OF THE FIGURES

Other advantages and features of the invention will become more clearly apparent from the following description of a specific embodiment of the invention given as non-restrictive example only and represented in the accompanying drawings in which:

FIG. 1 is a schematic illustration of a communications network for managing a fleet of rail vehicles in accordance with the invention;

FIG. 2 is a schematic illustration of a diagnostic system in accordance with the invention.

### DETAILED DESCRIPTION

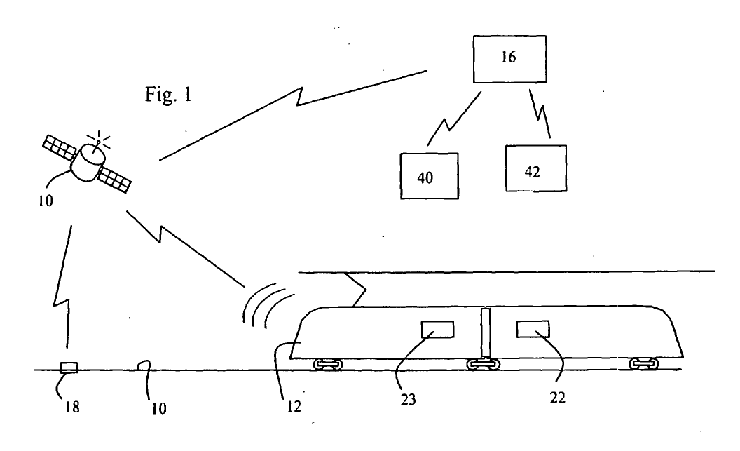

Referring to FIG. 1, a rail system comprises a rail infrastructure 10 consisting of tracks, junctions, overhead lines, railway stations, maintenance facilities, etc., and one or more fleets of rail vehicles 12 circulating on the tracks. The rail system is also provided with telecommunication means 14 for transmitting information to and from a data centre 16. These communication means may include wireless or hard-wired communications links such as a satellite system, cellular network, optical or infrared system or hard-wired phone line.

The rail infrastructure 10 is equipped with sensors 18 for monitoring events, linked to the data centre via the communication means. The monitored events can be related to one component of the rail infrastructure or to environmental conditions. By essence, these rail infrastructure-related sensors 18 are fixed and their position is known and stored in a database 20 of the data centre. Examples of such sensors are listed in table 1 below.

TABLE 1

| COMPONENT | SENSOR |
|---|---|
| Rail load | load cell |
| Rail vibration | Accelerometers; microphones |
| Footfall | CCTV, turnstile |
| Split switch | CCTV, proximity switches, pressure |
| status | switches |
| Crossing | CCTV, proximity switches, pressure |
| | switches |
| Platform | CCTV, proximity switches, pressure |
| | switches |
| Electrical | voltmeter; ammeter; wattmeter |
| energy input | |
| Track wetness, | CCTV |
| ice, leaves on | |
| the line etc. | |
| Train noise | Microphones |

Each rail vehicle of the fleet is equipped with a variety of sensors 22, including sensors for monitoring components or subsystems of the rail vehicle and sensors for monitoring environmental conditions, and a positioning system 23 for monitoring the position of the rail vehicle.

Table 2 below shows an example of the subsystems monitored and the data collected by on-board the rail vehicles of the fleet.

TABLE 2

| SUB-SYSTEM | SENSOR | MONITORED FUNCTIONALITY |
|---|---|---|
| Doors | Proximity switches | Door closing time |
| | (mechanical, | Door out of order |
| | optical or | Times between reopening |
| | magnetic) | Interlock broken without |
| | | release |
| | | Emergency egress handle |
| | | pulled |
| | | Door operation counter |
| | | Door performance |
| | | Dwell times |
| | | Passenger alarm |
| Engine | Engine notches | Coolant empty |
| | (the setting for | Engine over-temperature |
| | rate of | Scheduled maintenance: |
| | acceleration, on | Engine running hours |
| | the driver's | Coolant level |
| | control) | Load collective of engine |
| | Engine running | usage |
| | Coolant temp. | Running records |
| | sensor | |
| | Coolant level | |
| | switch | |
| | Coolant empty | |
| | detector | |
| Fuel system | Fuel level | Fuel leakage |
| | pressure switch | Scheduled maintenance: |
| | | Filling up regime |
| | | Miles per gallon |
| | | Gallons per hour |
| Battery | Voltage transducer | Low battery |
| | Charging/ | Counting of deep discharges |
| | discharging | Battery efficiency |
| | current transducer | |
| Secondary | Airbag pressure | Over/under pressure of |
| suspension | switches | airbags |
| | | Distance since last repair |
| | | Passenger counting system |
| Brake system | Brake actuator | Dragging brake |
| | proximity switches | Brake performance |
| | Brake lines | measurements |
| | pressure switches | Measurement of actuator |
| | Train speedometer | movement distance |
| | transducer | Brake pad wear prediction |
| | | Emergency brake event per |
| | | time or location |
| | | Braking force applied |
| | | Rate of slowing of rail |
| | | vehicle |
| Brake | Digital inputs | Brake release functionality. |
| interlock | from brake | Delay in releasing |
| supervision | interlock system | Residual resistive force |
| | | Actuator movement |
| Wheel slip/ | Train speedometer | Faulty WSP unit |
| slide | transducer | Scheduled maintenance |
| | Wheel spin | Mileage information |
| | Wheel slide | Wheel slip/slide per |
| | WSP (Wheel Slide | location |
| | Protection) fault | |
| Toilets | Level switches | Tank fill reduces on flush |
| | | Toilet tank 50% full |
| | | Toilet tank 80% full |
| | | Water tank empty |
| HVAC | Diagnostic link | Faulty HVAC unit |
| (heating, | from HVAC control | Operational mode |
| ventilation | system | Temperature measurement |
| and air | | Pressure measurement |
| conditioning | | Number of heating/cooling |
| system) | | cycles |
| | | Number of hours heating |
| | | Number of hours cooling |
| | | Energy consumption |

Table 3 below lists of environmental data gathered on-board:

TABLE 3

| PARAMETER | SENSOR |
|---|---|
| Ambient | Temperature probe or from HVAC (Heating, |
| temperature | Ventilation and Air Conditioning) system |
| | or other appropriate sensor |
| Location | Direct into VCU (Rail vehicle Control |
| | Unit) (from GPS) |
| Gradient | Gyroscope or upgraded GPS identifying |
| | altitude |
| Curve radius | Gyroscope or accelerometer |
| Lateral | Accelerometer |
| acceleration | |
| Ride comfort | Accelerometer attached to rail vehicle |
| | body |
| Track wetness, | Wheel Slip/slide Protection (WSP) |
| ice, leaves on | system. Alternatively, infra-red laser and |
| the line etc. | receiver for reflected laser light (with |
| | AI interface) |

The sensors, 18, 22 may include physical devices for measuring variables such as temperature, pressure, movement, proximity, electrical current and voltage, vibration and any other physical variable of interest. These “physical” sensors, such as temperature sensors, stress transducers, displacement transducers, ammeters, voltmeters, limit switches and accelerometers generate measured data indicative of the physical variables they sense. In addition to these physical sensors, the diagnostic system may also include “virtual” sensors which derive an estimated value of a physical variable by analysing measured data from one or more physical sensors and calculating an estimated measured data value for the desired physical variable. Virtual sensors may be implemented using software routines executing on a computer processor, hard-wired circuitry such as analogue and/or discrete logic integrated circuits, programmable circuitry such as application specific integrated circuits or programmable gate arrays, or a combination of any of these techniques.

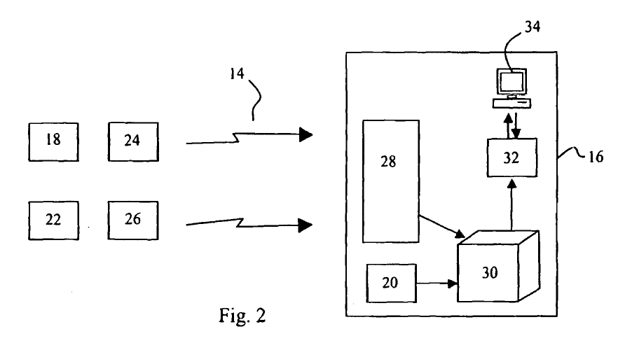

In the system depicted in FIG. 2, data from the on-board sensors and from the rail infrastructure-related sensors is subjected to pre-processing, such as filtering and digitisation by corresponding pre-processors 24, 26, and transmitted via the telecommunication means 14 to a data processing unit 28 of the data centre 16 where it may be subjected to further pre-processing.

Within the data processing unit 28, the pre-processed data from different sources is entered into a database 30. This set of data can be considered as a data cube, i.e. as a multidimensional object in a multidimensional space, in which at least three dimensions are considered of particular interest for discriminating particular events or patterns, namely the dimensions representing the time, the categories of events and the item identification number, which may be a rail vehicle number or rail infrastructure component identification number.

Accordingly, a main processing means 32 of the data centre is provided with extraction means allowing extraction of data in certain dimensions of the subspace. Such tools are well known in the art of computer programming, and reference can be made, if necessary, to “Data Cube: A Relational Aggregation Operator Generalizing Group-By, Cross-Tab, and Sub-Totals”, by Jim Gray et al., Data Mining and Knowledge Discovery 1, 29-53 (1997). The visualization and data analysis tools do “dimensionality reduction” by summarizing data along the dimensions that are left out. Further analysis tools include histogram, cross-tabulation, subtotals, roll-up and drill-down as is well known in the art of data analysis.

An operator interface 34 allows definition of different categories of events, each corresponding to a set of rail infrastructure-related sensors and/or rail vehicle-related sensors that prove to be technically inter-related. The data corresponding to one particular category can be merged so that data relating to a same point in time and space becomes available together as categorized events. A database of categorized events can be built for each operator.

Table 4 below shows examples of categories of monitored items and of corresponding rail infrastructure-related and rail vehicle-related sensor data.

TABLE 4

| | Rail Vehicle | Rail Infrastructure |
|---|---|---|
| Monitored Item | Sensors | Sensors |
| Rail vehicle doors | Door closing time | CCTV on platform |
| | Door operation | |
| | counter | |
| | Door performance | |
| Rail vehicle wheels | Bogie axle | Rail vibration |
| | vibration | Rail load |
| | Rail vehicle | |
| | distance travelled | |
| Rail vehicle brakes | Rail vehicle | CCTV |
| | distance travelled | |
| Rail vehicle damage | Rail vehicle | CCTV |
| | distance travelled | |
| Rail infrastructure | CCTV | Rail vehicle |
| damage | | passage counter |
| Rail vehicle axle | Rail vehicle | Hot axle box |
| bearings | distance travelled | detector |
| | | Acoustic sensors |
| Rail infrastructure | Rail vehicle | Overhead line |
| electric power | Pantograph or | tension |
| delivery | shoegear vibration | Overhead line |
| | CCTV | vibration |
| | Voltage | Overhead line |
| | Current | deflection |
| | | Third rail load |
| | | CCTV |
| Rail vehicle | Rail vehicle | Overhead line |
| electric power | distance traveled | tension |
| collection | Rail vehicle | Overhead line |
| | Pantograph or | vibration |
| | shoegear vibration | Overhead line |
| | CCTV | deflection |
| | Voltage | Third rail load |
| | Current | CCTV |

Categorized events of the same category can be compared over time for different rail vehicles of the fleet or different rail infrastructure components of the same type.

More specifically, the signal of a monitored component of a rail vehicle or of the rail infrastructure is correlated with “dynamic attributes” from other sensors, and with the time and location at which it occurs, from the GPS location signal. The dynamic attributes are parameters that are technically significant for the behaviour of the monitored component, e.g. parameters that may have a causal effect on the state of monitored component, or additional data useful for understanding the event, such as time of malfunction and operation being undertaken at the time of malfunction. For example, in trying to analyze wheels, the data will be visualised by car number, number of events. Accordingly, other aspects such as doors will be ignored. Filters can be used to select the analysed data, e.g. rail vehicle range, vehicle speed higher than a predetermined value, rail infrastructure range, etc.

The data centre 16 is linked to rail vehicle maintenance facilities 40, rail infrastructure maintenance facilities 42 and can issue recommendations to the maintenances facilities 40, 42 and to the rail vehicles 12 when a fault is detected or preventive maintenance is advisable. The maintenance facilities are preferably provided with reporting tools for reporting the results of the maintenance operations. This feedback data can be used to feed a database of historical events 44, and correlated with the recommendations issued by the data centre to assess the relevance and accuracy. The database of historical events 44 can also be used to built a behaviour model for each monitored component of the rail system, i.e. a database containing data indicative of tolerances ranges, normal conditions and trends. The sensor data can then be compared to the behaviour model to more efficiently predict future faults.

It will be appreciated that thanks to the diagnostic system of the invention it becomes possible to merge data from the rail infrastructure with data from the fleet of rail vehicles for continuous monitoring and fault detection. New strategies can therefore be developed for predicting faults relating to the rail infrastructure or the rail vehicles allowing a proactive maintenance and service of the rail system as a whole.

It is to be understood that the invention is not intended to be restricted to the details of the above embodiment which are described by way of example only.

1. A diagnostic system for monitoring a rail system comprising a rail infrastructure and at least one fleet of rail vehicles circulating on the rail infrastructure, the diagnostic system comprising:
an on-board data acquisition system comprising sensors and pre-processing means responsive to the sensors for generating rail vehicle-related sensor data representative of the operation of monitored rail vehicle components and/or of the rail vehicle environment of each rail vehicle of the fleet;
a rail vehicle positioning system for generating position data representative of the position of each rail vehicle of the fleet;
a rail infrastructure data acquisition system comprising sensors fixed relative to the rail infrastructure and pre-processors responsive to the sensors for generating rail infrastructure-related sensor data representative of rail infrastructure components and/or of the rail infrastructure environment;
a database of the rail infrastructure comprising location data representative of the location of each of the sensors fixed relative to the rail infrastructure;
a data processing unit for merging the rail infrastructure-related sensor data, the rail vehicle-related sensor data from at least a subset of several rail vehicles of the fleet, the location data, and the position data, and for responsively generating a series of categorized event data representative of the occurrence of categorized events at a given location on the rail infrastructure over time and/or on a given rail vehicle of the fleet over time; and
a data comparing unit for comparing the series of categorized events data representative of at least one category of events over any predetermined period of time and for identifying a location of the rail infrastructure and/or a rail vehicle which exhibits a series of events data that is significantly different from other locations of the rail infrastructure and/or rail vehicles of the fleet over said predetermined period of time.

2. The diagnostic system of claim 1, wherein the data comparing unit further comprises a data categorization unit comprising an operator interface for defining categories of events by entering which rail vehicle-related data and which rail infrastructure-related data is included in a category of events.

3. The diagnostic system of claim 1, wherein the data comparing unit further comprises a visualizing unit for simultaneously visualising the compared series of condition data.

4. The diagnostic system of claim 1 wherein the data comparing unit is adapted for counting the number of occurrences of a predetermined event in each series, and for comparing said numbers of occurrences.

5. The diagnostic system of claim 1 wherein the data comparing unit is adapted for comparing the series of condition data representative of at least one of the monitored components on at least one rail vehicle of the fleet over a predetermined period of time to a stored fault occurrence database in order to determine whether the at least one rail vehicle has experienced a fault.

6. The diagnostic system of claim 1 wherein the system is adapted for selecting said subset of rail vehicles.

7. The diagnostic system of claim 1, wherein the data comparing unit is adapted for for selecting said predetermined period of time.

8. A fleet maintenance system for maintaining a fleet of rail vehicle, comprising a diagnostic system according to claim 1, the fleet maintenance system being adapted for issuing a recommendation to a maintenance facility regarding a rail vehicle identified as exhibiting a series of events data that is significantly different from the other rail vehicles of the fleet over said predetermined period of time.

9. The fleet maintenance system of claim 8, further comprising a reporting tool located at the maintenance facility for reporting the result of an onsite analysis of any identified component of the identified rail vehicle.

10. A method for monitoring a rail system comprising a rail infrastructure and at least one fleet of rail vehicles circulating on the rail infrastructure, the method comprising:
generating rail vehicle-related data representative of the operation of monitored rail vehicle components and/or of the rail vehicle environment of each rail vehicle of the fleet;
generating position data representative of the position of each rail vehicle of the fleet;
generating rail infrastructure-related data representative of rail infrastructure components and/or of the rail infrastructure environment;
merging the rail infrastructure-related data and the rail vehicle-related data from at least a subset of several rail vehicles of the fleet, with location data from a location database representative of the location of each of the sensors fixed relative to the rail infrastructure and the position data of each rail vehicle of the subset;
generating a series of categorized events data representative of the occurrence of categorized events at a given location on the rail infrastructure over time and/or on a given rail vehicle of the fleet over time; and
comparing the series of categorized events data representative of at least one category of events over a predetermined period of time and for identifying a location of the rail infrastructure and/or a rail vehicle which exhibits a series of events data that is significantly different from other locations of the rail infrastructure and/or rail vehicles of the fleet over said predetermined period of time.
